(19) United States
(12) Patent Application Publication
(10) Pub. No.: US 2026/0253404 A1
(43) Pub. Date: Aug. 27, 2026

(54) INFORMATION PROCESSING DEVICE, INFORMATION PROCESSING METHOD, AND NON-TRANSITORY COMPUTER-READABLE RECORDING MEDIUM

(71) Applicant: Olive Corporation, Aichi (JP)

(72) Inventor: Seiji TAKEUCHI, Aichi (JP)

(21) Appl. No.: 19/648,544

(22) Filed: Apr. 15, 2026

Related U.S. Application Data
(63) Continuation of application No. PCT/JP2023/037339, filed on Oct. 16, 2023.

(51) Int. Cl. G06V 10/82; G06N 20/00; G06T 7/00; G06T 7/246; G06V 10/56; G06V 10/62; G06V 10/774

(52) U.S. Cl. CPC G06V 10/82; G06N 20/00; G06T 7/0012; G06T 7/246; G06V 10/56; G06V 10/62; G06V 10/774; G06T 2207/20081; G06T 2207/20084; G06T 2207/30076; G06T 2207/30088

(57) ABSTRACT

An information processing device includes a processor configured to acquire first training information including at least first information satisfying a predetermined condition of importance in estimation among information for causing an estimator that performs the estimation based on input information to train features, and second training information including predetermined second information in addition to the first information, and train the estimator by using the first training information, and to, after the training using the first training information, train the estimator trained using the first training information, by using the second training information.

### CROSS-REFERENCE TO RELATED APPLICATION

This application is a continuation application of International Application PCT/JP2023/037339, filed on Oct. 16, 2023, and designating the U.S., the entire contents of which are incorporated herein by reference.

### FIELD

The present invention relates to an information processing device, an information processing method, and an information processing program.

### BACKGROUND

In the related art, techniques have been known to perform an estimation from various information.

The related technologies are described, for example, Japanese Patent Application Laid-open No. 2017-029318.

### SUMMARY

According to an aspect of an embodiment, an information processing device includes a processor configured to acquire first training information including at least first information satisfying a predetermined condition of importance in estimation among information for causing an estimator that performs the estimation based on input information to train features, and second training information including predetermined second information in addition to the first information, and train the estimator by using the first training information, and to, after the training using the first training information, train the estimator trained using the first training information, by using the second training information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of an information processing system according to an embodiment.

FIG. 2 is a diagram illustrating an example of information processing according to an embodiment.

FIG. 3 is an explanatory diagram for explaining the overall flow of a model.

FIG. 4 is an explanatory diagram for explaining a training process according to an embodiment.

FIG. 5 is a diagram illustrating an example of a configuration of an information display device according to an embodiment.

FIG. 6 is a diagram illustrating an example of a configuration of an information processing device according to an embodiment.

FIG. 7 is a diagram illustrating an example of a sensor information storage unit according to an embodiment.

FIG. 8 is a diagram illustrating an example of a model information storage unit according to an embodiment.

FIG. 9 is a diagram illustrating an example of the architecture of a first model.

FIG. 10 is a diagram illustrating an example of the architecture of a second model.

FIG. 11 is a diagram illustrating an example of the architecture of a third model.

FIG. 12 is a flowchart (1) showing an example of an information processing procedure according to an embodiment.

FIG. 13 is a flowchart (2) showing an example of an information processing procedure according to an embodiment.

FIG. 14 is a hardware configuration diagram illustrating an example of a computer that implements the functions of the information processing device.

### DESCRIPTION OF EMBODIMENTS

However, the techniques described above have not been able to properly perform an estimation in real time when performing the estimation from various information.

The following is a detailed description of a form (hereinafter, referred to as an “embodiment”) for implementing an information processing device, an information processing method, and an information processing program according to the present application, with reference to the drawings. This embodiment does not limit the information processing device, the information processing method, and the information processing program according to the present application. In each of the following embodiments, identical parts are marked with the same symbol and redundant explanations thereof are omitted.

A technique for measuring blood flow by using light called photoplethysmography (PPG) is known. For example, animals with various circulatory systems have blood flowing through their bodies, and the amount of such flow of blood, that is, blood flow, varies with the pulsation of the heart. The speed (that is, pulse), strength (that is, blood pressure), and the like of the pulsation of the heart vary depending on the physical and mental conditions of the animal. Therefore, it can also be said that changes in a blood flow rate can be used to estimate the physical and mental conditions of the animal.

It is known that the blood of common homeothermic animals (especially, mammals) has hemoglobin, which selectively absorbs light at specific wavelengths (especially, green light). As a blood flow rate increases due to an increase in blood pressure or heart rate, the amount of light absorbed at specific wavelengths also increases. Measurement devices that measure blood flow by PPG irradiate the skin and other parts of the body with light and measure reflected light by using photodiodes or other devices. Subsequently, the measurement device can calculate the absorbance of the light at the specific wavelength from the intensity of the light at the specific wavelength in the irradiated light and the intensity of the light at the specific wavelength in the reflected light, and estimate a blood flow rate on the basis of the calculated absorbance.

The PPG technique can also be applied to measure pulses indicating fluctuations in a blood flow rate from moving images, that is, PPG pulses. The technique of measuring the PPG pulse from the moving image is also called VPPG (the technique is sometimes also referred to as remote PPG or rPPG). For example, since blood flow exists in the skin, changes in such blood flow change the absorbance of light at specific wavelengths, resulting in changes in skin tint due to changes in blood flow. VPPG is a technique of measuring the PPG pulse based on changes in skin tint. Facial skin is known to be particularly suitable for measurement because of the concentration of blood vessels in the face.

Various methods for VPPG are known. For example, when a subject is not in an action state such as sitting, methods are known to detect faces using a predetermined algorithm for detecting faces from moving images (for example, the Viola-Jones method or the like) and to measure the PPG pulse using optical signal channels from the entire face or a part of the face. Methods are known to measure the PPG pulse by separating a heartbeat signal from a raw signal using blind source separation (BSS). Methods are also known to measure the PPG pulse by extracting a heartbeat signal from a raw signal using power spectral density (PSD) analysis. Methods are also known to measure the PPG pulse by adjusting the background brightness using normalized least mean squared (NLMS) adaptive filter and suppressing the effects of changes in brightness.

In addition to methods for suppressing the effects of changes in brightness, methods are also known to suppress the effects of changes in motion. For example, methods are known to use algorithms that allow a robust estimation using pixel-based remote PPG sensors. Methods are known to take into account the translational movement of each image pixel between frames by using, for example, an optical flow algorithm using the Farneback method. Note that the optical flow algorithm using the Farneback method is a high-density optical flow algorithm and may have a larger information processing load than an optical flow algorithm using the Lucas-Kanade method.

In addition, the shift in color space can effectively suppress the effects of changes in brightness and the effects of changes in motion. In addition, delays in volume pulse wave (BVP) estimation can be suppressed due to computational efficiency. In addition, red, green, and blue (RGB) require filtering processing. Since principal component analysis (PCA) and independent component analysis (ICA) are also required, the shift in color space may be required. Note that PCA and ICA are both methods of scaling dimensions and may result in significant delays in BVP estimation.

The VPPG method described above is known to use an artificial convolutional neural network (CNN) and the like in combination with long short-term memory layers, an attention mask for measuring VPPG from moving images, and the like. However, these neural networks tend to increase in the number of nodes, the number of layers, and the like in order to improve accuracy, and the load for real-time use can be significant.

In the following embodiment, convolutional neural networks are used to measure VPPG. Also, in the use of the convolutional neural networks, reducing the size of the network and making the network lighter allows for real-time use.

In the related art, techniques are known for performing an estimation from various information. For example, techniques are known for ascertaining the state of a subject by reading biometric information of the subject from moving images. For example, techniques are known for generating heart rate data from face images and ascertaining the stress state of a subject.

However, the techniques described above have not been able to properly perform an estimation in real time when performing the estimation from various information. For example, the techniques described above could not properly estimate the state of a subject from moving images in real time due to a heavy information processing load and lack of robust state estimation.

### Embodiment

### 1. Configuration of Information Processing System

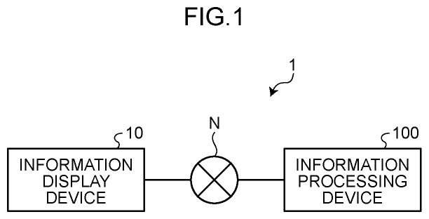

First, an information processing system 1 according to an embodiment is described. FIG. 1 is a diagram illustrating an example of a configuration of the information processing system 1 according to an embodiment. As illustrated in FIG. 1, the information processing system 1 includes an information display device 10 and an information processing device 100. The information display device 10 is communicatively connected to the information processing device 100 via a predetermined communication network (network N) in a wired or wireless manner. The information processing system 1 illustrated in FIG. 1 may include a plurality of information display devices 10 and a plurality of information processing devices 100.

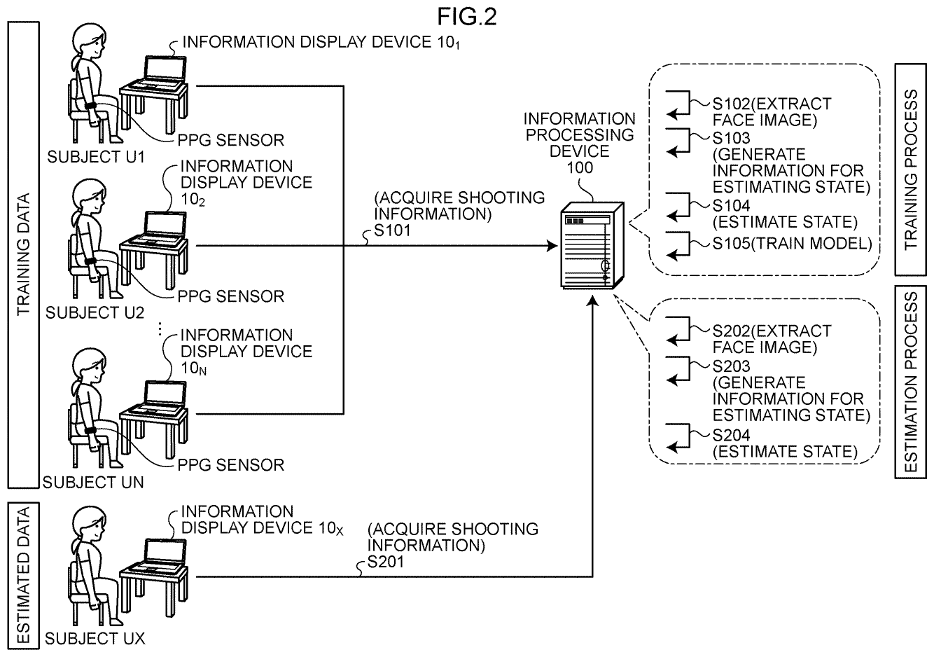

The information display device 10 is an information processing device used by a subject. The information display device 10 may be any device that can implement processing in the embodiment. The information display device 10 may be a smartphone, a tablet terminal, a notebook PC, a desktop PC, a mobile phone, a PDA, or other device. In the example illustrated in FIG. 2, the information display device 10 is a notebook PC.

The information display device 10 is, for example, a smart device such as a smartphone or a tablet, and is a portable terminal device capable of communicating with any server device via wireless communication networks such as 4G to 5G (generation) or long term evolution (LTE). The information display device 10 may also have a screen, such as a liquid crystal display, that has a touch panel function, and may receive various operations such as tapping, sliding, and scrolling on display data such as content from the subject using a finger, stylus, or the like. In FIG. 2, the information display device 10 is used by a subject U. For example, information display devices 10₁ to 10_{N} are used by subjects U1 to UN, respectively. For example, an information display device 10_{X} is used by a subject UX. The subjects U1 to UN are subjects collected to generate training data of a neural network, and the subject UX is a subject whose state is estimated by applying a trained neural network. The information display device 10 may also have an imaging device such as a camera in order to capture images of the subject U.

The information processing device 100 is an information processing device for the purpose of appropriately estimating the state of a subject from moving images in real time, and may be any device that can implement processing in the embodiment. The information processing device 100 is implemented with, for example, a server device or a cloud system that provides services on the basis of the state of the subject. The information processing device 100, for example, generates a skin image including at least a part of the skin of the subject from the moving image, and estimates the state of the subject in real time by using a convolutional neural network.

FIG. 1 illustrates the case in which the information display device 10 and the information processing device 100 are separate devices; however, the information display device 10 and the information processing device 100 may be integrated.

Here is an overview of how the information processing device 100 can implement VPPG using neural networks in real time, prior to an example of the information processing performed by the information processing device 100.

The information processing device 100 uses roughly three stages of information processing to estimate the state of the subject from images. Specifically, the information processing device 100 performs a process of extracting a range where the subject was taken from the image, a process of estimating the PPG pulse of the subject from the extracted range, and a process of estimating the state of the subject from the PPG pulse. Separate neural networks are employed in these processes, respectively.

In general, the convolutional neural network used in the process of estimating the PPG pulse of the subject from the extracted range tends to be large in scale because it has a large number of nodes and a large number of layers in order to estimate the PPG pulse from the image. This may increase the amount of computation in neural network-based processing, which may impair real-time performance.

Improving the accuracy of neural network-based information processing may be achieved not only by increasing the scale of NNs, such as the number of nodes and the number of layers, but also by improving a training method. The applicant has found a method for improving the accuracy of NNs by NN training methods without increasing the size of the NNs.

When the accuracy of NNs can be improved, even NNs of a scale that can be executed in real time can be as accurate as or more accurate than NNs of a larger scale. In other words, when a certain level of accuracy is required in VPPG and training is performed using a NN training method discovered by the applicant, the size of NNs can be reduced and NNs that can be executed in real time can be trained, compared to the related art.

Therefore, by training NNs using a new NN training method, the information processing device 100 prevents an increase in the size of NNs and implements the provision of NNs that can execute VPPG in real time.

In addition to the NN of the process of estimating the PPG pulse of the subject from the extracted range, the NN of the process of extracting the range where the subject was taken from the image and the NN of the process of estimating the state of the subject from the PPG pulse can also employ a new NN training method to ensure real-time performance.

### 2. Example of Information Processing

FIG. 2 is a diagram illustrating an example of the information processing of the information processing system 1 according to the embodiment. The subjects U1 to UN are in a sitting position and are fitted with biometric sensors (for example, PPG sensors, respiration sensors, or the like). For example, a PPG sensor may be worn on the earlobe and a respiration sensor may be worn under the chest. The PPG sensor and the respiration sensor are examples of the biometric sensor and the biometric sensor is not limited to these examples. For neural network training, the subjects U1 to UN are, for example, encouraged to remain relaxed at first, and then are encouraged to solve a mental arithmetic problem that causes a stressful state. The subject UX is in a sitting position, but is fitted with no biometric sensor such as a PPG sensor.

The following embodiment describes an example in which the information processing device 100 extracts a face image as an example of a skin image including at least a part of the skin of the subject U; however, the skin image to be extracted need not be limited to a face image. For example, in the following embodiment, the information processing device 100 may extract arm images, leg images, and the like of the subject U. The following embodiment describes an example in which the information processing device 100 estimates the stress state as an example of the state of the subject U; however, the state to be estimated need not be limited to the stress state. For example, in the following embodiment, the information processing device 100 may estimate the state (for example, joy, anger, sorrow, pleasure, and the like) related to the emotions of the subject U.

### Training Process

The following is a description of the training process of the information processing device 100. The information processing device 100 acquires shooting information (corresponding to moving images) of the subjects U1 to UN (step S101). For example, the information processing device 100 acquires shooting information by capturing the images of the subjects U1 to UN in real time. Specifically, the shooting information is images constituting a moving image.

The information processing device 100 extracts a face image from the acquired shooting information as a skin image including at least a part of the skin of the subjects U1 to UN (step S102). For example, the information processing device 100 extracts face images by applying a single-shot multibox detector (SSD). Hereinafter, a model used to extract face images from the shooting information is referred to as a “first model” as appropriate. In the following embodiment, any method of extracting face images from the shooting information may be used; however, the present invention need not be limited to the method using the first model. The single-shot multibox detector is an example of the first model.

The information processing device 100 applies the extracted face images to a convolutional attention neural network (CAN) to generate information for estimating the stress state of the subjects U1 to UN (for example, heart rate data, respiration data, and the like) (step S103). Hereinafter, a model used to generate the information for estimating the stress state from the face images is referred to as a “second model” as appropriate. The convolutional attention neural network is an example of the second model (corresponding to an estimator).

The information processing device 100 estimates the stress states of the subjects U1 to UN from the generated information (step S104). For example, the information processing device 100 estimates the stress state by applying a residual convolutional neural network (for example, a parallel 1D residual convolutional neural network or the like). Hereinafter, a model used to estimate the stress state is referred to as a “third model” as appropriate. In the following embodiment, any method of estimating the stress state may be used; however, the present invention need not be limited to the method using the third model. The residual convolutional neural network is an example of the third model.

In the following embodiment, the first model, the second model, and the third model are collectively referred to as “models” as appropriate. The information processing device 100 trains the models by using information of the subjects U1 to UN as correct answer data (step S105). For example, the information processing device 100 trains the second model by using the information of the subjects U1 to UN as correct answer data. In this case, the information processing device 100 may train at least one of the first model and the third model by using the information of the subjects U1 to UN as correct answer data. In addition, the information processing device 100 uses information output from the model and information from the actual biometric sensor, such as a PPG sensor, to train the model so that the information output from the model approaches the information from the biometric sensor. For example, the information processing device 100 trains the models (the first model, the second model, the third model, the first model/the second model, the first model/the third model, the second model/the third model, or the first model/the second model/the third model) so that information output from the third model (information indicating the stress state) approaches the information from the biometric sensor.

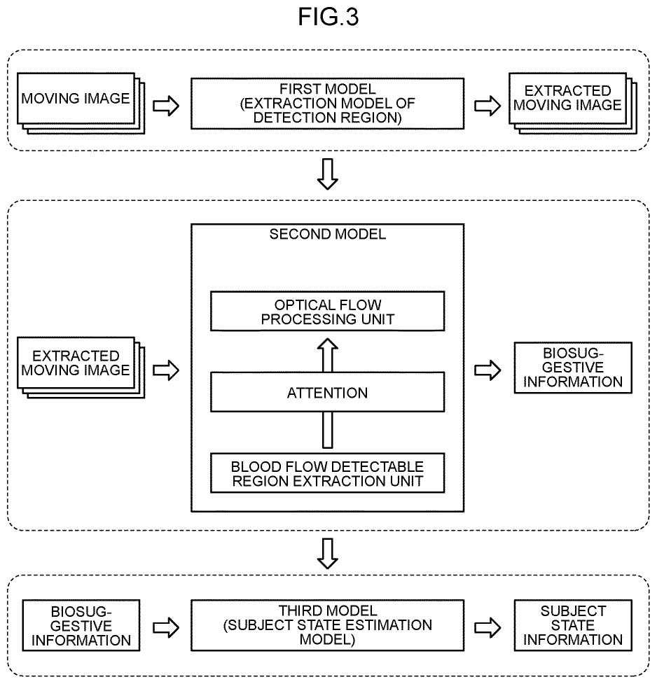

FIG. 3 is here used to explain the overall flow of the model. FIG. 3 is an explanatory diagram for explaining the overall flow of the model. In a first step, the first model is used to extract appropriate regions such as a person's face from a moving image (for example, regions including person's skin, such as a person's face and hands, that is, a region estimated to change a color according to blood flow) as an estimation source of subject state information, and to generate an extracted moving image.

In a second step, the second model is used to generate information serving as a basis for estimating the state of the subject from the extracted moving image, for example, biosuggestive information suggestive of blood flow, pulse, or the like. The second model has a blood flow detectable region extraction unit that extracts regions of the extracted moving image where blood flow is detectable, and an optical flow processing unit that processes the optical flow features of the extracted moving image. The blood flow detectable region extraction unit generates information indicating which regions of each pixel in the extracted image need be emphasized, that is, attention, and the optical flow processing unit generates biosuggestive information from an optical flow image in consideration of the importance according to the attention for each region of the optical flow image. In a third step, the third model is used to generate the subject state information from the biosuggestive information. The subject state information is, for example, information on the emotions of the subject U.

### Training Environment

The training environment is described below. The training environment according to the embodiment need not be limited to the following examples. As an example of the training environment according to the embodiment, for example, a biometric sensor may be connected to the Biosignal Plux Hub. For example, the sampling rate of the biometric sensor may be set to a predetermined sampling rate (for example, 256 Hz, 700 Hz, or the like). For example, a general web camera may be used to capture a moving image having a resolution of a predetermined number of pixels (for example, 680×420 pixels or the like) and a frame rate of a predetermined FPS (for example, 30 FPS or the like). For example, a camera may be installed at a predetermined distance (for example, 0.5 m or the like) from the face. For example, in order to increase contrast, a black cloth or the like may be used so that the background is black. For example, after each session of encouraging relaxation and encouraging the subject to solve mental arithmetic problems, pleasure, discomfort, stress, and the like may be evaluated using self-assessment manikin (SAM) as a subjective evaluation (for example, the degree of pleasure, discomfort, stress, and the like may be evaluated). For example, images may be captured by a plurality of cameras to increase the number of samples. For example, images may be taken of the subject wearing a mask so as to be applicable to even when a part of the subject's face is hidden.

For example, a data set may also be generated with different time frames, different shooting angles, different shooting distances, different shooting illuminance (lighting settings), and the like. For example, a data set may also be generated with subjects of different attributes (for example, age, gender, nationality, skin color, and the like). For example, a data set may also be generated with a subject wearing a mask in some training environments, a subject wearing no mask in some training environments, and the like. For example, a data set may also be generated with a black background in some training environments, a non-black background (for example, white or the like) in some training environments, and the like. For example, a data set may also be generated with a subject in a normal state (for example, a stress-free state or the like) in some training environments, a subject in a stressed state in some training environments, and the like. For example, in each of moving images, a data set for the case of no face may also be generated by extracting a background moving image and the like in regions other than the face. For example, a data set may also be generated to be applicable to fake faces by capturing fake face moving images and the like of faces captured in magazines or on screens. For example, a data set including various information such as a plurality of different angles, illuminance, age, distance, and skin color may also be generated.

The information processing device 100 may, for example, use the data set generated in this way to acquire information including information of a person who is the subject as first information and to acquire information including information of a person who is not the subject as second information. The information processing device 100 may, for example, use the data set generated in this way to acquire information including, as first information, information of a predetermined type among the information of a person who is the subject and to acquire information including, as second information, information of a type other than the predetermined type among the information of a person who is the subject. The information processing device 100 may, for example, use the data set generated in this way to acquire information including, as first information, skin information of a person who is the subject and to acquire information including, as second information, information, other than the skin information, among the information of a person who is the subject.

### Data Expansion and Data Preprocessing

Data expansion and data preprocessing are described below. The data expansion and the data preprocessing according to the embodiment need not be limited to the following examples. At least one of the data expansion and the data preprocessing may be performed prior to model training in order to obtain accurate results in an estimation process. The data expansion or the data preprocessing may be performed by the information processing device 100 or via an external information processing device or other device.

As an example of the data expansion according to the embodiment, for example, a predetermined conversion process may be performed on the shooting information. For example, conversions such as rotation (for example, random rotation or the like), addition (for example, pixel addition or the like), inversion (for example, left-to-right or up-down inversion or the like), and shearing may be performed. These conversions may also be performed randomly. The data expansion may be performed to artificially increase the number of samples. The data expansion is also effective in generalizing the model so that it can be adapted even when not included in an original data set.

As an example of the data preprocessing according to the embodiment, for example, a predetermined conversion process may be performed on the shooting information. For example, a face size may be converted to a predetermined pixel size (for example, 36×36 pixels or the like). For example, optical flow features may be extracted and normalized for model training. As an example of the data preprocessing according to the embodiment, for example, a predetermined conversion process may be performed on information from a biometric sensor such as a PPG sensor. For example, noise removal may be performed by a filtering process.

### Estimation Process

The estimation process of the information processing device 100 is described below. The same explanations as for the training process are omitted as appropriate. The information processing device 100 acquires shooting information obtained by capturing images of the subject UX (step S201). For example, the information processing device 100 acquires shooting information obtained by capturing the images of the subject UX in real time.

The information processing device 100 extracts a face image from the acquired shooting information as a skin image including at least a part of the skin of the subject UX (step S202). In this case, the information processing device 100 may use the first model such as a single-shot multibox detector. Subsequently, the information processing device 100 generates information (biosuggestive information) for estimating the stress state of the subject UX by applying the extracted face image to the convolutional attention neural network that is a trained second model (step S203). In this way, the information processing device 100 generates the information (biosuggestive information) for estimating the stress state of the subject UX by applying the extracted face image to the trained model trained in the training process. Subsequently, the information processing device 100 estimates the stress state of the subject UX from the generated information (step S204). In this case, the information processing device 100 may use the third model such as a residual convolutional neural network.

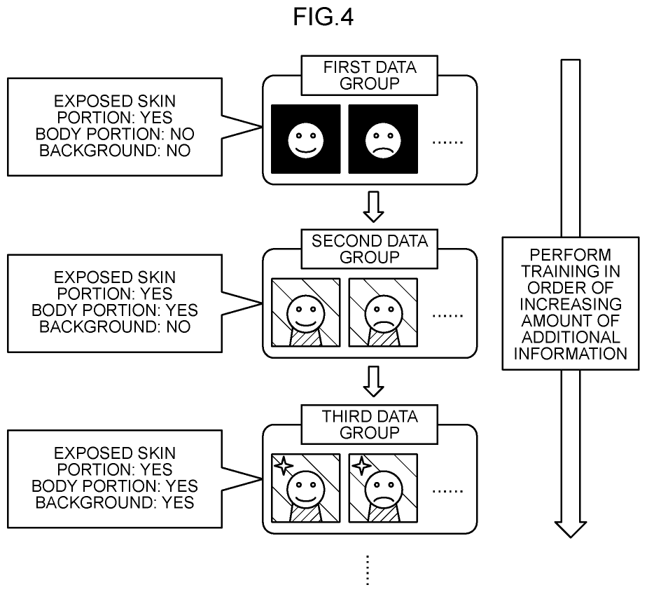

FIG. 4 is here used to explain the training process according to the embodiment. FIG. 4 is an explanatory diagram for explaining the training process according to the embodiment. Specifically, by stepwisely training additional data that gradually adds information from essential data, models that are small in size but ultimately highly accurate can be generated. For example, the information processing device 100 generates, as training data, a group of images with stepwisely more additional information, such as body and background portions, by generating only exposed skin portions such as the face (that is, only portions where color changes in response to blood flow can be expected) as principle training data. Subsequently, the information processing device 100 generates data groups such as a first data group, a second data group, and a third data group in the order of increasing amount of additional information, and performs training in the order of increasing amount of additional information. After training on the first data group and when an error is below a predetermined threshold, training is subsequently performed on the second data group. By so doing, instead of suddenly performing a process based on the features of the clothing and background, the model performs principled training from the features of a portion intended to serve as a basis of an estimation process in principle and gradually increases the amount of additional information, thereby allowing training for estimating exceptional conditions. As a result, the model training is optimized for accuracy based on principled information, and then gradually further optimized for accuracy by considering additional information, so that accuracy can be improved as a result of optimization based on principles and considering exceptions, rather than optimization of accuracy based on exceptions. As a result, accuracy can be ensured even for models with small model sizes, so that real-time performance can be ensured. For example, in the first data group, training is performed using a black background in order to eliminate features of a background portion, and in the second data group, training is performed using a background including black and other colors in the features of the background portion. In the third data group, the features of the background up to the second data group and sections of frames with no faces are trained to generate samples with no faces (for example, in the third data group, when there are sections of frames with faces and sections with no faces, the frame sections with no faces may be trained as “no face”). In a fourth data group, training is performed using the features up to the third data group, fake face frames acquired from magazines, newspapers, external screens, or the like, and thus a data group including only the principles and a plurality of data groups with stepwisely increasing amount of additional information are prepared and training is performed for each data group in the order of increasing amount of additional information. In this way, instead of performing training from exceptions, the principles can be trained and the additional information can be increased stepwisely to improve robustness against errors due to the additional information.

### 3. Configuration of Information Display Device

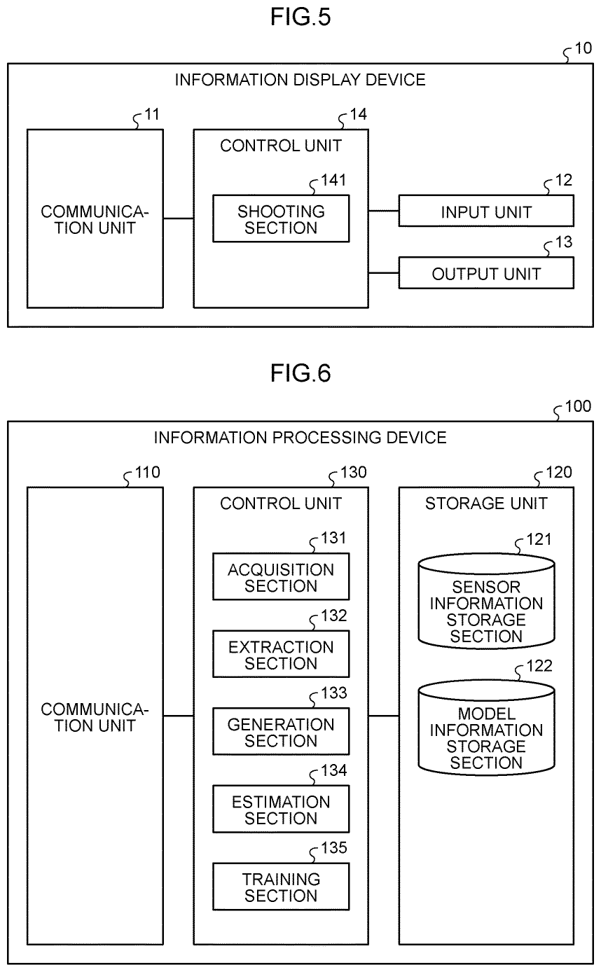

FIG. 5 is used to explain the configuration of the information display device 10 according to the embodiment. FIG. 5 is a diagram illustrating an example of the configuration of the information display device 10 according to the embodiment. As illustrated in FIG. 5, the information display device 10 has a communication unit 11, an input unit 12, an output unit 13, and a control unit 14.

### Communication Unit 11

The communication unit 11 is implemented with, for example, a network interface card (NIC) or the like. The communication unit 11 is connected to a predetermined network N wirelessly or by wire, and transmits and receives information to and from the information processing device 100 or the like via the predetermined network N.

### Input Unit 12

The input unit 12 receives various operations from the subject. In the example illustrated in FIG. 2, various operations are received from the subject U (subjects U1 to UN and UX). For example, the input unit 12 may receive various operations from the subject via a display surface by using a touch panel function. The input unit 12 may also receive various operations from buttons provided on the information display device 10 or a keyboard or a mouse connected to the information display device 10.

### Output Unit 13

The output unit 13 is a display screen, such as a tablet terminal implemented with, for example, a liquid crystal display, an organic electro-luminescence (EL) display, or the like, and is a display device for displaying various information. For example, the output unit 13 displays information transmitted from the information processing device 100.

### Control Unit 14

The control unit 14 is, for example, a controller, which is implemented by a central processing unit (CPU), a micro processing unit (MPU), or the like executing various computer programs stored in a storage device inside the information display device 10 and using a random access memory (RAM) as a work area. For example, these various programs include application programs installed in the information display device 10. For example, these various programs include application programs for capturing the subject in real time. The control unit 14 is implemented with, for example, an integrated circuit such as an application specific integrated circuit (ASIC) or a field programmable gate array (FPGA).

As illustrated in FIG. 5, the control unit 14 has a shooting section 141, and implements or performs information processing actions to be described below.

### Shooting Section 141

The shooting section 141 captures images in real time. For example, the shooting section 141 captures images of the subject in real time. In addition, the shooting section 141 transmits shooting information obtained by capturing to an external information processing device in real time. For example, the shooting section 141 transmits the shooting information to other information processing devices such as the information processing device 100 in real time.

### 4. Configuration of Information Processing Device

FIG. 6 is used to explain the configuration of the information processing device 100 according to the embodiment. FIG. 6 is a diagram illustrating an example of the configuration of the information processing device 100 according to the embodiment. As illustrated in FIG. 6, the information processing device 100 has a communication unit 110, a storage unit 120, and a control unit 130. The information processing device 100 may have an input unit (for example, a keyboard, a mouse, or the like) for receiving various operations from an administrator of the information processing device 100 and a display unit (for example, a liquid crystal display or the like) for displaying various information.

### Communication Unit 110

The communication unit 110 is implemented with, for example, a NIC or the like. The communication unit 110 is connected to the network N wirelessly or by wire, and transmits and receives information to and from the information display device 10 or the like via the network N.

### Storage Unit 120

The storage unit 120 is implemented with, for example, a semiconductor memory element such as a RAM and a flash memory, or a storage device such as a hard disk and an optical disk. As illustrated in FIG. 6, the storage unit 120 has a sensor information storage section 121 and a model information storage section 122.

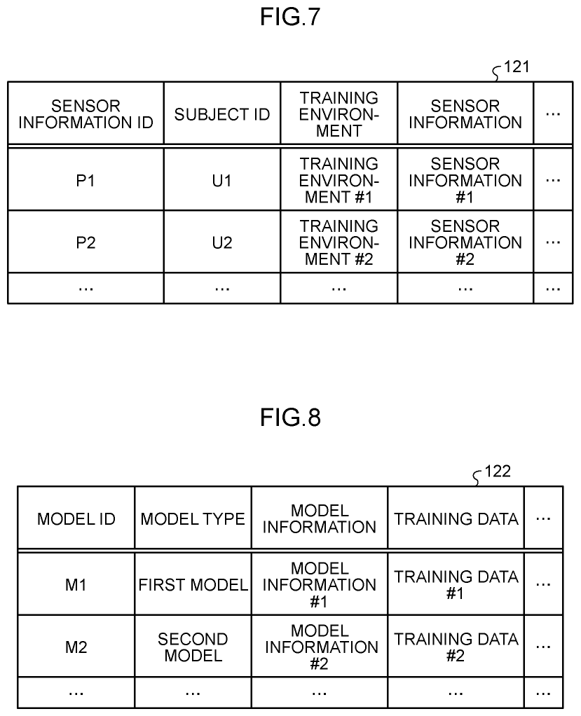

The sensor information storage section 121 stores information from the biometric sensor such as the PPG sensor. For example, the sensor information storage section 121 stores information from the biometric sensor worn by the subject for model training. FIG. 7 illustrates an example of the sensor information storage section 121 according to the embodiment. As illustrated in FIG. 7, the sensor information storage section 121 has items such as “sensor information ID”, “subject ID”, “training environment”, and “sensor information”.

The “sensor information ID” indicates identification information for identifying sensor information. The “subject ID” indicates identification information for identifying the subject. The “training environment” indicates a training environment. FIG. 7 illustrates an example in which conceptual information such as “training environment #1” and “training environment #2” is stored in the “training environment”, but actually, a numerical value indicating a sampling rate, a numerical value indicating a resolution, a numerical value indicating a frame rate, a numerical value indicating a distance from the subject, a numerical value indicating a shooting angle, a numerical value indicating shooting illuminance, information indicating the attributes of the subject, information indicating whether the subject is wearing a mask, information indicating a background color, information indicating whether the subject is under stress, and the like are stored. The “sensor information” indicates information of the biometric sensor. FIG. 7 illustrates an example in which conceptual information such as “sensor information #1” and “sensor information #2” is stored in the “sensor information”, but actually, raw data such as heart rate data measured by the PPG sensor and respiration data measured by the respiration sensor is stored. Data and the like after the data expansion or the data preprocessing may also be stored.

The model information storage section 122 stores information on models. For example, the model information storage section 122 stores information on models trained to approach the information from the biometric sensor. FIG. 8 illustrates an example of the model information storage section 122 according to the embodiment. As illustrated in FIG. 8, the model information storage section 122 has items such as “model ID”, “model type”, “model information”, and “training data”.

The “model ID” indicates identification information for identifying models. The “model type” indicates the type of model for identifying whether a model is the first model, the second model, or the third model. The “model information” indicates information on the model. FIG. 8 illustrates an example in which conceptual information such as “model information #1” and “model information #2” is stored in the “model information”, but actually, information and the like indicating model elements and weights are stored. The “training data” indicates training data used to train the model. FIG. 8 illustrates an example in which conceptual information such as “training data #1” and “training data #2” is stored in “training data”, but actually, shooting information and the like used to train the model are stored. Shooting information and the like after the data expansion or the data preprocessing may also be stored.

### Control Unit 130

The control unit 130 is a controller, which is implemented with, for example, a CPU, an MPU, or the like executing various computer programs stored in a storage device inside the information processing device 100 and using a RAM as a work area. The control unit 130 is implemented with, for example, an integrated circuit such as an ASIC or an FPGA.

As illustrated in FIG. 6, the control unit 130 has an acquisition section 131, an extraction section 132, a generation section 133, an estimation section 134, and a training section 135, and implements or performs information processing actions to be described below. The internal configuration of the control unit 130 is not limited to the configuration illustrated in FIG. 6, but may be configured in other ways as long as it is configured to perform information processing to be described below.

### Acquisition Section 131

The acquisition section 131 acquires various information. The acquisition section 131 acquires various information from an external information processing device. For example, the acquisition section 131 acquires various information from another information processing device such as the information display device 10.

The acquisition section 131 acquires various information from the storage unit 120. For example, the acquisition section 131 acquires various information from the sensor information storage section 121 and the model information storage section 122. The acquisition section 131 stores the acquired various information in the storage unit 120. For example, the acquisition section 131 stores various information in the sensor information storage section 121 and the model information storage section 122.

The acquisition section 131 acquires shooting information obtained by capturing images of the subject in real time. For example, the acquisition section 131 acquires shooting information transmitted in real time from an external information processing device. For example, the acquisition section 131 acquires shooting information transmitted in real time from another information processing device such as the information display device 10.

### Extraction Section 132

The extraction section 132 extracts a skin image (for example, a face image or the like) including at least a part of the skin of the subject from the shooting information acquired by the acquisition section 131. For example, the extraction section 132 extracts the skin images by using a first model (for example, a single-shot multibox detector or the like). In this case, the extraction section 132 may, for example, extract the skin image by using a first model that is an existing model, extract the skin image by using a first model generated by the training section 135 to be described below, or extract the skin image by using a trained first model obtained by training the existing first model by the training section 135 to be described below.

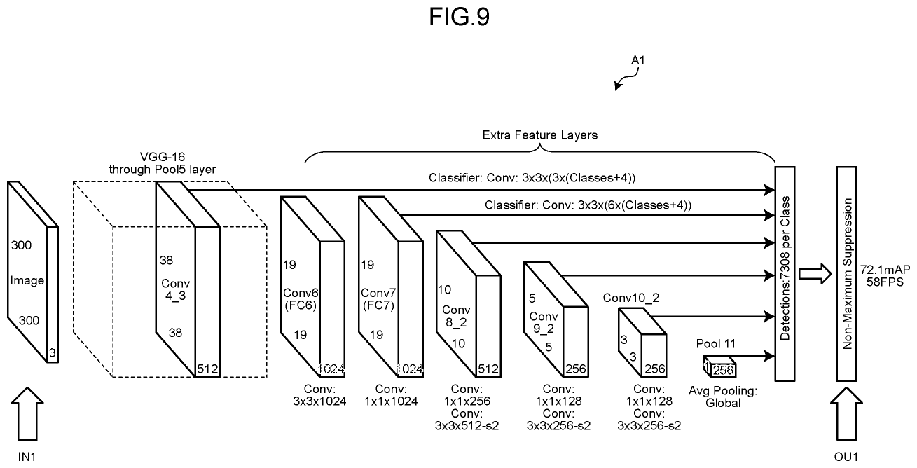

FIG. 9 is here used to explain details of the first model according to the embodiment. The single-shot multibox detector is described as an example. FIG. 9 is a diagram illustrating an example of the architecture of the first model. The first model may be an architecture based on a slicing method of sequentially dividing the shooting information into regions of a predetermined size and performing detection sequentially for each divided region, or an architecture based on a grid cell method of pre-dividing the shooting information into a predetermined number of regions and performing detection for each divided region.

In FIG. 9, IN1 is the shooting information and is input information that is input to A1 that is the architecture of the first model. In addition, OU1 is the skin image and is output information output from A1. The first model may include a plurality of CNNs in the architecture. For example, the first model may include at least a fully convolutional neural network based on MobileNet-v2 and a residual convolutional neural network, respectively.

The following describes a training method for the first model. As an example of the training method for the first model, for example, a loss function such as a mean squared error may be used. For example, optimization methods such as ADAM (Lr=0.001) may also be used. For example, padding may also be set to “enabled” or the like. For example, the number of epochs may be set to “32” or the like. For example, a batch size may be set to “32” or the like. The first model may be trained by modifying connection coefficients between nodes by backpropagation or the like so that when images constituting each frame of a moving image are input, the model extracts an exposed skin portion, such as a person's face and hands, that is, a range with optical characteristics that allow blood flow to be estimated.

In the first model, for example, MobileNet-v2 may be trained on an ImageNet data set. For example, weights acquired from MobileNet-v2 may be fixed and training may be performed. For example, a residual convolutional neural network may be trained using half of a predetermined data set (for example, a public data set including face boundary boxes, such as WIDER). For example, training may also be performed by unfixing the weights and reducing a learning rate to as low as 1 in 100,000. For example, training may also be further performed using a predetermined data set (for example, a public data set including a face boundary box and 98 landmarks, such as WFLW) to increase robustness when the subject is wearing a mask. For example, training may also be performed using stride 2 without a pooling layer.

### Generation Section 133

The generation section 133 generates a second model, which is a model that is smaller in size but ultimately more accurate, by stepwisely training additional data that gradually adds information. Specifically, the generation section 133 prepares a data group including only principles and a plurality of data groups with stepwisely increasing amount of additional information, and trains each data group in the order of increasing amount of additional information, thereby generating the second model. For example, the generation section 133 prepares (1) a data group for training with only faces, (2) a data group for training with only faces and bodies, (3) a data group for training with faces, bodies, and background (black and white), and (4) a data group for training with faces, bodies, and background (color), and trains each data group in the order of (1), (2), (3) and (4) in which the amount of additional information increases, thereby generating the second model. For example, the generation section 133 prepares data groups for training with fake faces and bodies in the same way, and trains each data group, thereby generating the second model. For example, the generation section 133 prepares a data group for training with the face and body of the subject, a data group for training with a fake face and the body of the subject, and a data group for training with a fake face and a fake body, and trains each data group, thereby generating the second model. When an error is below a predetermined threshold (when loss convergence is reached again), the generation section 133 trains a data group with the next smallest amount of additional information, repeats this process, and performs training for estimating exceptional conditions, thereby generating the second model. In this way, the generation section 133 performs principled training from the features of a portion intended to serve as a basis of an estimation process in principle, trains a data group with the next smallest amount of additional information when an error is below a predetermined threshold, and performs training for estimating exceptional conditions by gradually increasing the amount of additional information, thereby generating the second model.

The generation section 133 generates biosuggestive information (for example, heart rate data, respiration data, or the like) of the subject from the skin image extracted by the extraction section 132. For example, the generation section 133 generates the biosuggestive information of the subject by using a second model (for example, a convolutional attention neural network or the like). In this case, the generation section 133 may, for example, generate the biosuggestive information of the subject by using a second model that is an existing model, generate the biosuggestive information of the subject by using a second model generated by the training section 135 to be described below, or generate the biosuggestive information of the subject by using a trained second model obtained by training the existing second model by the training section 135 to be described below.

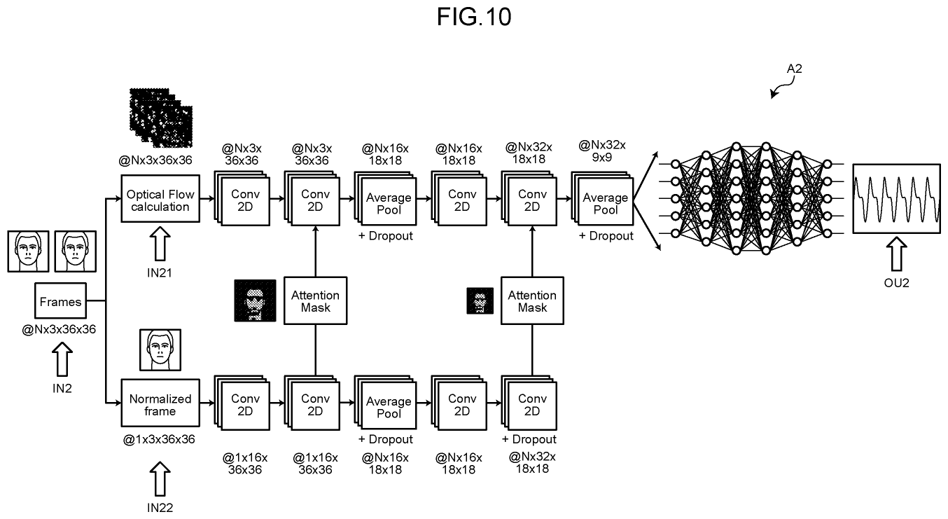

FIG. 10 is here used to explain details of the second model according to the embodiment. The convolutional attention neural network is described as an example. FIG. 10 is a diagram illustrating an example of the architecture of the second model.

In FIG. 10, IN2 is the skin image and is input information that is input to A2 that is the architecture of the second model. In addition, OU2 is the biosuggestive information of the subject and is output information output from A2. OU2 may be de-trended for signal equalization. IN21 is information generated by extracting optical flow features of IN2, and IN22 is information generated by normalizing IN2 for use in an attention mask. That is, A2 performs convolution by using IN22 as the attention mask and applying IN22 to IN21. A2 includes a first component that extracts features based on a moving image and a second component that generates information for estimation on the basis of optical flow features based on the moving image.

The following describes a training method for the second model. As an example of the training method for the second model, for example, a loss function such as a mean squared error may be used. For example, optimization methods such as adaptive-delta (Lr=1.0 to 0.1, to 0.01, and to 0.001) may also be used. For example, padding may also be set to “enabled” or the like. For example, the stride may be set to “1” or the like. For example, the number of epochs may be set to “370” or the like. For example, a batch size may be set to “128” or the like. For example, the batch size may be set to be a multiple of a frame depth (a parameter set when designing A2). For example, each batch may be set to be regarded as an independent signal. The second model may be trained by modifying connection coefficients between nodes by backpropagation or the like so that when a skin image including at least a portion of exposed skin is input, the model extracts biosuggestive information based on the optical characteristics of the portion.

In the second model, for example, training may be performed on a predetermined data set (for example, a public data set such as PURE, or the like) and then on a data set excluding unnecessary biological data (for example, a private data set or the like). For example, when training is performed using heart rate data, training may be performed on a data set excluding respiration data.

In the second model, for example, training may be performed with randomly set weights. For example, training may be performed at a high learning rate of “1.0”. For example, training may be initially performed only with face moving images. In this way, training may be initially performed only with basic information. For example, some data from the subject may be used for training. For example, about 20% of the data may be used for evaluation and the remaining about 80% of the data may be used for training. For example, after a predetermined number of iterations, training may be performed by reducing the learning rate. For example, training may be performed by reducing the learning rate by a factor of 10. For example, training may be initially performed only with the face moving image, but then may be performed including a background image. In this way, training may be performed while gradually increasing information from the basic information. For example, after loss convergence is reached (after evaluated loss has stopped decreasing), training may be performed until loss convergence is reached again. For example, training may be performed on fake face images. For example, after loss convergence is reached, training may be performed by reducing the learning rate. For example, training may be performed while fine-tuning the model through an iterative process of reducing the learning rate. For example, training may be performed by applying dedicated fine tuning to enable the model to respond to a specific environment.

The second model may also have the blood flow detectable region extraction unit that extracts regions of the extracted moving image where blood flow is detectable and the optical flow processing unit that processes the optical flow features of the extracted moving image, in FIG. 3.

### Estimation Section 134

The estimation section 134 estimates the state of the subject (for example, a stress state or the like) from the information generated by the generation section 133. For example, the estimation section 134 estimates the state of the subject by using a third model (for example, a residual convolutional neural network or the like). In this case, the estimation section 134 may, for example, estimate the state of the subject by using a third model that is an existing model, estimate the state of the subject by using a third model generated by the training section 135 to be described below, or estimate the state of the subject by using a trained third model obtained by training the existing third model by the training section 135 to be described below.

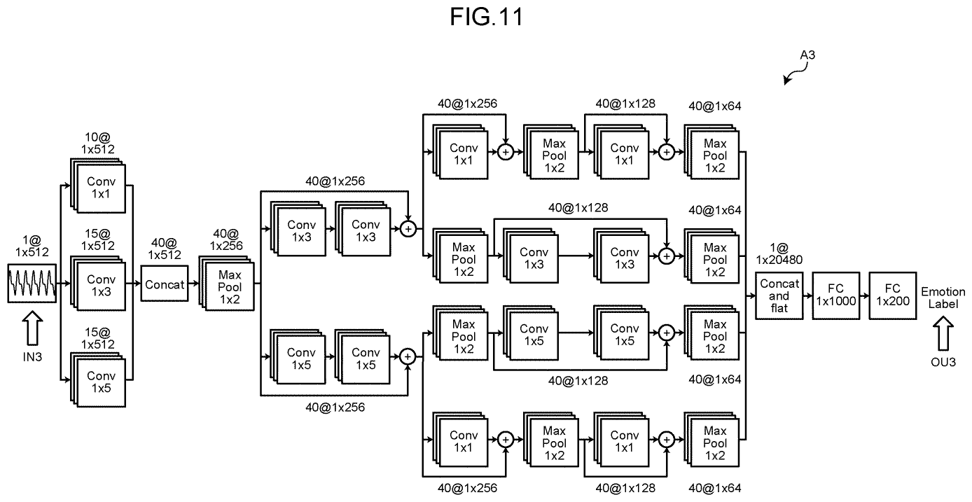

FIG. 11 is here used to explain details of the third model according to the embodiment. The residual convolutional neural network is described as an example. FIG. 11 is a diagram illustrating an example of the architecture of the third model.

In FIG. 11, IN3 is the information generated by the generation section 133 and is input information that is input to A3 that is the architecture of the third model. In addition, OU3 is information indicating the state of the subject and is output information output from A3. IN3, for example, is information with a sampling rate of 128 Hz, a signal length of 10 seconds, and a slice of 2 seconds.

The following describes a training method for the third model. As an example of the training method for the third model, for example, a loss function such as categorical cross entropy or binary cross entropy may be used. For example, optimization methods such as ADAM may also be used. For example, padding may also be set to “enabled” or the like. For example, the number of epochs may be set to “100” or the like. For example, a batch size may be set to “64” or the like. The third model may be trained by modifying connection coefficients between nodes by backpropagation or the like so that when biosuggestive information based on optical characteristics of an exposed skin portion is input, the model extracts information estimated on the basis of the optical characteristics of the portion and indicating the state of the subject.

In the third model, for example, after training is performed on a predetermined data set (for example, a public data set such as WESAD, or the like), training may further be performed on a different data set (for example, a private data set or the like).

### Training Section 135

The training section 135 trains a model. For example, the training section 135 trains at least one of the first model, the second model, and the third model. For example, when the information of the subject, which is training data, is input to the model as correct answer data, the training section 135 trains the model so that the information output from the model approaches actual biometric sensor information.

The training section 135, for example, trains the first model by using a predetermined data set (for example, WIDER, WFLW, or the like). The first model may be an existing model, a model generated by the training section 135, or a trained model obtained by training the existing model using a predetermined data set.

The training section 135, for example, trains the second model by using a predetermined data set (for example, PURE or the like). The second model may be an existing model, a model generated by the training section 135, or a trained model obtained by training the existing model using a predetermined data set.

The training section 135, for example, trains the third model by using a predetermined data set (for example, WESAD or the like). The third model may be an existing model, a model generated by the training section 135, or a trained model obtained by training the existing model using a predetermined data set.

The training section 135 trains a model by using, for example, information (corresponding to the first training information) including at least first information satisfying a predetermined condition of importance in estimation among information for causing the model to train features. Subsequently, the training section 135 further trains the model by using, for example, information (corresponding to the second training information) including predetermined second information in addition to the first information.

The training section 135 performs training using the first training information, for example, until the difference between the first training information and output information (corresponding to first output information) output by the model when the first training information is input to the model satisfies a predetermined condition. In addition, the training section 135 trains the model trained using the first training information, for example, until the difference between the second training information and output information (corresponding to second output information) output by the model when the second training information is input to the model satisfies a predetermined condition.

The training section 135 performs training using the first training information, for example, until the loss of the first output information relative to the first training information converges below a predetermined threshold. In addition, the training section 135 performs training using the second training information, for example, until the loss of the second output information relative to the second training information converges below a predetermined threshold.

The training section 135, for example, causes the model to train features of the second training information at a lower learning rate than in the training using the first training information.

### 5. Flow of Information Processing

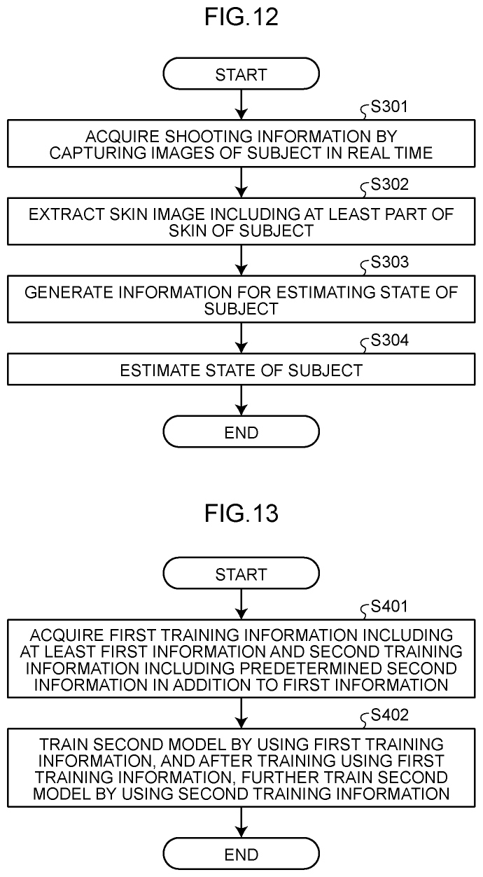

FIGS. 12 and 13 are used to explain the information processing procedure performed by the information processing system 1 according to the embodiment. FIGS. 12 and 13 are flowcharts showing the information processing procedure performed by the information processing system 1 according to the embodiment.

As illustrated in FIG. 12, the information processing device 100 acquires shooting information by capturing the images of the subject in real time (step S301).

The information processing device 100 extracts a skin image including at least a part of the skin of the subject by using the first model (step S302).

The information processing device 100 generates information for estimating the state of the subject by using the second model (step S303).

The information processing device 100 estimates the state of the subject by using the third model (step S304).

As illustrated in FIG. 13, the information processing device 100 acquires the first training information including at least the first information and the second training information including the predetermined second information in addition to the first information (step S401).

The information processing device 100 trains the second model by using the first training information, and after training using the first training information, further trains the second model by using the second training information (step S402).

### 6. Modification

The information processing system 1 according to the embodiment described above may be implemented in a variety of different forms in addition to the above embodiment. Therefore, other embodiments of the information processing system 1 are described below.

The above embodiment shows a case in which the information processing device 100 acquires the shooting information of a subject captured in real time by the information display device 10, but need not be limited to this example. For example, the information processing device 100 may acquire pre-recorded recording information from an external information processing device or other device. For example, the information processing device 100 may estimate the state of a subject appearing in a pre-recorded moving image. This also enables visualization of the state of performers in a movie, a drama, or the like at the time of filming by applying the information processing device 100 to pre-recorded moving images, for example.

### 7. Effects

As described above, the information processing device 100 according to the embodiment has the acquisition section 131 and the training section 135. The acquisition section 131 acquires first training information including at least first information satisfying a predetermined condition of importance in estimation among information for causing an estimator that performs the estimation based on input information to train features, and second training information including predetermined second information in addition to the first information. The training section 135 trains the estimator by using the first training information, and trains, after the training using the first training information, the estimator trained using the first training information, by using the second training information.

This allows the information processing device 100 according to the embodiment to make a proper estimation in real time when making an estimation from various information.

The training section 135 performs training using the first training information until a difference between the first training information and first output information output by the estimator when the first training information is input to the estimator satisfies a predetermined condition, and trains the estimator trained using the first training information until a difference between the second training information and second output information output by the estimator when the second training information is input to the estimator satisfies a predetermined condition.

This allows the information processing device 100 according to the embodiment to perform training from basic information while gradually increasing information, thereby enabling highly accurate estimation with a small model.

The training section 135 performs training using the first training information until loss of the first output information relative to the first training information converges below a predetermined threshold, and performs training using the second training information until loss of the second output information relative to the second training information converges below a predetermined threshold.

This allows the information processing device 100 according to the embodiment to enable more accurate training by setting conditions for training when gradually increasing information.

The training section 135 causes the estimator to train features of the second training information at a lower learning rate than in the training using the first training information.

This allows the information processing device 100 according to the embodiment to enable highly accurate training while reducing a load on the training process.

The acquisition section 131 acquires, as the first training information, information including, as first information, information of a person, and acquires, as the second training information, information including, as second information, information other than the information of the person, a state of the person being estimated using the estimator.

This allows the information processing device 100 according to the embodiment to be applied to person state estimation.

The acquisition section 131 acquires, as the first training information, information including, as first information, information of a predetermined type among information of a person, and acquires, as the second training information, information including, as second information, information of a type other than the predetermined type among the information of the person, a state of the person being estimated using the estimator.

This allows the information processing device 100 according to the embodiment to train models by using any information of a person as basic information when applied to person state estimation.

The acquisition section 131 acquires, as the first training information, information including, as first information, skin information of a person, and acquires, as the second training information, information including, as second information, information other than the skin information among information of the person, a state of the person being estimated using the estimator.

This allows the information processing device 100 according to the embodiment to train models by using skin information of a person as basic information when applied to person state estimation.

The acquisition section 131 acquires an image constituting a moving image as the first training information and the second training information. The training section 135 trains a neural network as the estimator that estimates a state of a captured object captured in the moving image on the basis of the image constituting the moving image.

This allows the information processing device 100 according to the embodiment to estimate the state of a captured object in real time from the moving image.

The training section 135 trains a neural network including a first component that is a neural network that extracts features based on an input moving image as the neural network, and a second component that generates information for estimation on the basis of optical flow features based on the moving image and the features extracted by the first component.

This allows the information processing device 100 according to the embodiment to perform training based on optical flow features, thereby enabling efficient training.

The training section 135 trains a neural network that estimates the state of the captured object captured in the moving image on the basis of an image after data expansion or data preprocessing for the image constituting the moving image.

This allows the information processing device 100 according to the embodiment to perform data expansion or data preprocessing, thereby enabling more accurate training.

### 8. Hardware Configuration

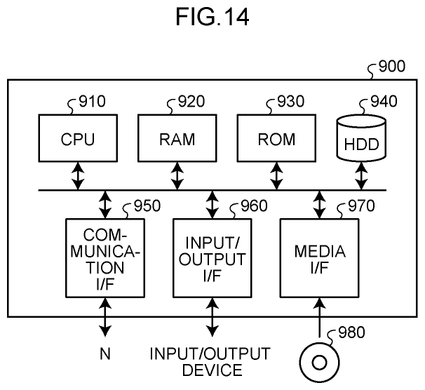

The information display device 10 and the information processing device 100 according to the embodiment described above are implemented with, for example, a computer 900 with a configuration illustrated in FIG. 14. FIG. 14 is a hardware configuration diagram illustrating an example of a computer that implements the functions of the information display device 10 and the information processing device 100. The computer 900 has a CPU 910, a RAM 920, a ROM 930, an HDD 940, a communication interface (I/F) 950, an input/output interface (I/F) 960, and a media interface (I/F) 970.

The CPU 910 operates on the basis of a computer program stored in the ROM 930 or the HDD 940 and controls each part. The ROM 930 stores a boot program executed by the CPU 910 when the computer 900 is started up, as well as computer programs dependent on the hardware of the computer 900.

The HDD 940 stores computer programs executed by the CPU 910, data used by such computer programs, and the like. The communication I/F 950 acquires data from other devices via a predetermined communication network, transmits the acquired data to the CPU 910, and transmits data generated by the CPU 910 to the other devices via the predetermined communication network.

The CPU 910 controls output devices such as displays and printers and input devices such as keyboards and mice via the input/output I/F 960. The CPU 910 acquires data from the input devices via the input/output I/F 960. The CPU 910 also outputs generated data to the output devices via the input/output I/F 960.

The media I/F 970 reads computer programs or data stored on recording media 980 and provides the read computer programs or data to the CPU 910 via the RAM 920. The CPU 910 loads such computer programs onto the RAM 920 from the recording media 980 via the media I/F 970, and executes the loaded computer programs. The recording media 980 are, for example, optical recording media such as digital versatile discs (DVDs), phase change rewritable disks (PDs), optical magnetic recording media such as magneto-optical disks (MOs), tape media, magnetic recording media, or semiconductor memories.

For example, when the computer 900 functions as the information display device 10 and the information processing device 100 according to the embodiment, the CPU 910 of the computer 900 executes the computer programs loaded onto the RAM 920 to implement the functions of the control units 14 and 130. The CPU 910 of the computer 900 reads and executes these computer programs from the recording media 980, but as another example, the CPU 910 may acquire these computer programs from other devices via a predetermined communication network.

### 9. Others

Of the respective processes described in the above embodiments, all or a part of the processes described as being performed automatically can be performed manually, or all or a part of the processes described as being performed manually can be performed automatically by known methods. Other information including processing procedures, specific names, and various data and parameters shown in the above documents and illustrated in drawings can be changed as desired, unless otherwise noted. For example, various information illustrated in each drawing is not limited to the information illustrated.

In addition, each component of each device illustrated in the drawing is a functional concept and does not necessarily have to be physically configured as illustrated in the drawing. That is, the specific form of dispersion and integration of each device is not limited to that illustrated in the drawing, but can be configured by functionally or physically dispersing and integrating all or a part of the devices in arbitrary units according to various loads and usage conditions.

The above-described embodiments can be combined as appropriate to the extent that they do not contradict each other in terms of processing content.

The above is a detailed description of some of the embodiments of the present application on the basis of the drawings. These are examples, and the present invention can be implemented in other forms with various variations and improvements on the basis of the knowledge of those skilled in the art, including the forms described in the disclosure section of the invention.

In addition, the above-described “unit (section, module, and unit)” can be read as “means” or “circuit”. For example, the acquisition section can be read as an acquisition means or an acquisition circuit.

The present invention can properly perform an estimation in real time when performing the estimation from various information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is

1. An information processing device comprising
a processor configured to:
acquire first training information including at least first information satisfying a predetermined condition of importance in estimation among information for causing an estimator that performs the estimation based on input information to train features, and second training information including predetermined second information in addition to the first information; and
train the estimator by using the first training information, and to, after the training using the first training information, train the estimator trained using the first training information, by using the second training information.

2. The information processing device according to claim 1, wherein the training includes
performing training using the first training information until a difference between the first training information and first output information output by the estimator when the first training information is input to the estimator satisfies a predetermined condition, and
training the estimator trained using the first training information until a difference between the second training information and second output information output by the estimator when the second training information is input to the estimator satisfies a predetermined condition.

3. The information processing device according to claim 2, wherein the training includes
performing training using the first training information until loss of the first output information relative to the first training information converges below a predetermined threshold, and
performing training using the second training information until loss of the second output information relative to the second training information converges below a predetermined threshold.

4. The information processing device according to claim 1, wherein the training includes causing the estimator to train features of the second training information at a lower learning rate than in the training using the first training information.

5. The information processing device according to claim 1, wherein the acquiring includes acquiring, as the first training information, information including, as first information, information of a person, and acquires, as the second training information, information including, as second information, information other than the information of the person, a state of the person being estimated using the estimator.

6. The information processing device according to claim 1, wherein the acquiring includes acquiring, as the first training information, information including, as first information, information of a predetermined type among information of a person, and acquires, as the second training information, information including, as second information, information of a type other than the predetermined type among the information of the person, a state of the person being estimated using the estimator.

7. The information processing device according to claim 1, wherein the acquiring includes acquiring, as the first training information, information including, as first information, skin information of a person, and acquires, as the second training information, information including, as second information, information other than the skin information among information of the person, a state of the person being estimated using the estimator.

8. The information processing device according to claim 1, wherein
the acquiring includes acquiring an image constituting a moving image as the first training information and the second training information, and
the training includes training a neural network as the estimator that estimates a state of a captured object captured in the moving image on the basis of the image constituting the moving image.

9. The information processing device according to claim 8, wherein the training includes training a neural network including
a first component that is a neural network that extracts features based on an input moving image as the neural network, and
a second component that generates information for estimation on the basis of optical flow features based on the moving image and the features extracted by the first component.

10. The information processing device according to claim 8, wherein the training includes training a neural network that estimates the state of the captured object captured in the moving image on the basis of an image after data expansion or data preprocessing for the image constituting the moving image.

11. An information processing method comprising:
acquiring first training information including at least first information satisfying a predetermined condition of importance in estimation among information for causing an estimator that performs the estimation based on input information to train features, and second training information including predetermined second information in addition to the first information; and
training the estimator by using the first training information, and training, after the training using the first training information, the estimator trained using the first training information, by using the second training information, by a processor.

12. A non-transitory computer-readable recording medium having stored therein an information processing program that causes a computer to execute a process comprising:
acquiring first training information including at least first information satisfying a predetermined condition of importance in estimation among information for causing an estimator that performs the estimation based on input information to train features, and second training information including predetermined second information in addition to the first information; and
training the estimator by using the first training information, and training, after the training using the first training information, the estimator trained using the first training information, by using the second training information.
